(19) United States
(12) Patent Application Publication
(10) Pub. No.: US 2006/0113965 A1
(43) Pub. Date: Jun. 1, 2006

(54) Secondary battery module

(76) Inventors: Yoon-Cheol Jeon, Suwon-si (KR); Tae-Yong Kim, Suwon-si (KR); Gun-Goo Lee, Suwon-si (KR); Kyu-Woong Cho, Suwon-si (KR)

Correspondence Address: CHRISTIE, PARKER & HALE, LLP, PO BOX 7068, PASADENA, CA, 91109-7068, US

(21) Appl. No.: 11/290,986

(22) Filed: Nov. 29, 2005

(30) Foreign Application Priority Data
Nov. 30, 2004 (KR) 10-2004-0099319
Mar. 28, 2005 (KR) 10-2005-0025431

(51) Int. Cl. H02J 7/00

(52) U.S. Cl. 320/150

(57) ABSTRACT

A secondary battery module includes a body having a channel for channeling a cooling medium and a plurality of receiving portions mounted on the body, wherein unit batteries are insertable into the plurality of receiving portions.

### CROSS-REFERENCES TO RELATED APPLICATION

This application claims priority to and the benefit of Korean Patent Application Nos. 10-2004-0099319 filed on Nov. 30, 2004, and 10-2005-0025431 filed on Mar. 28, 2005, both applications filed in the Korean Intellectual Property Office, the entire contents of which are incorporated herein by reference.

### BACKGROUND OF THE INVENTION

1. Field of the Invention

The present invention relates to a secondary battery module having a plurality of unit batteries.

2. Description of the Related Art

Unlike a primary battery, a secondary battery may be recharged. Lower power batteries are used for various portable electronic devices such as phones, laptop computers, and camcorders. Bulk size batteries are used as the power source for driving motors, such as those in hybrid electric vehicles.

Depending on their external shape, secondary batteries may be classified into different types, for example, prismatic and cylindrical batteries. When they are used to drive motors of machines requiring a high power source such as hybrid electric vehicles, the secondary batteries may be formed into a high power secondary battery module.

A secondary battery module is formed by serially connecting several secondary batteries (hereinafter “unit battery”). Each of the unit batteries includes an electrode assembly in which a separator is interposed between a positive electrode and a negative electrode. The electrode assembly is inserted inside a container, and a cap assembly is assembled with the container to seal the container. The cap assembly may include terminals extending from the interior to the exterior of the container and the terminals may be electrically connected to the positive electrode and the negative electrode.

If the unit batteries are prismatic type batteries, the unit batteries are arranged such that positive and negative terminals of one unit battery alternate with the positive and negative terminals of an adjacent unit battery. Electric conductor adaptors are typically mounted on the negative and positive terminals such that they are electrically connected to form the battery module. Additionally, some portion of the outer circumferential surface of the positive terminal and the negative terminal may be threaded.

Since the battery module connects several to tens of unit batteries to form one battery module, there is a need to efficiently disperse heat generated from each unit battery. In particular, when unit batteries are packaged as bulk size secondary batteries for driving motors such as those in electric vehicles, hybrid electric vehicles, motor scooters, and vacuum cleaners, heat dispersion is of significant importance.

If heat dispersion does not occur properly in the battery module, the temperature of the battery module may increase excessively. Accordingly, both the battery module and the device powered by the battery module may malfunction.

If unit batteries of a secondary battery module have a cylindrical shape, these unit batteries are arranged in a predetermined pattern, such as in two rows within a rectangular case. However, in such a structure, the configuration of the unit battery does not correspond to the configuration of the case, thus creating unusable space within the case and limiting the number of cylindrical unit batteries mountable within the case.

Such structural limitation of the secondary battery module is an obstacle to maximizing the capacity of the secondary battery module.

### SUMMARY OF THE INVENTION

A secondary battery module is provided which maximizes cooling efficiency for a unit battery.

According to one embodiment of the present invention, a secondary battery module includes a body having a channel for a cooling medium and a plurality of receiving portions mounted on the body, wherein unit batteries are insertable into the plurality of receiving portions. The plurality of the receiving portions may be radially arranged on the body and fixed to the body, such as by welding.

The body may be cylindrical or it may have a polygonal cross section. The receiving portion may have a shape corresponding to a shape of the unit battery. The unit battery may be combined with the receiving portion by a screw fixation method or by a forced insertion method. The body and the receiving portion may be made of aluminum or copper. Additionally, an insulating member may be interposed between the receiving portion and the unit battery.

The secondary battery module may further include an outer case surrounding the body and the receiving portion, the outer case being supported by the receiving portion. The outer case may have a hexagonal cross section.

A plurality of the secondary battery modules may be mounted in a container with a predetermined shape. The secondary battery modules may be arranged in a honeycomb structure. The container may have a square or circular cross section.

### BRIEF DESCRIPTION OF THE DRAWINGS

FIG. 1 is a schematic partially exploded perspective view of a secondary battery module according to an exemplary embodiment of the present invention.

FIG. 2 is a cross-sectional front view of the secondary battery module of FIG. 1.

FIG. 3 is a sectional perspective view of a battery receiving portion of the secondary battery module of FIG. 1.

FIG. 4 is a cross-sectional side view of the secondary battery module according to FIG. 1.

FIG. 5 is a cross-sectional front view of a secondary battery module according to another exemplary embodiment of the first embodiment of the present invention.

FIG. 6 is a schematic partially exploded perspective view of a secondary battery module according to yet another exemplary embodiment of the present invention.

FIG. 7 is a front view of the secondary battery module according to FIG. 5.

FIG. 8 is a cross-sectional side view of the secondary battery module of FIG. 6.

FIG. 9 is a front view of a secondary battery module according to still another exemplary embodiment of the present invention.

FIG. 10 is a front view of a secondary battery module according to yet another exemplary embodiment of the second embodiment of the present invention.

FIG. 11 is a schematic block diagram showing a rechargeable battery driving a motor according to an embodiment of the present invention.

### DETAILED DESCRIPTION

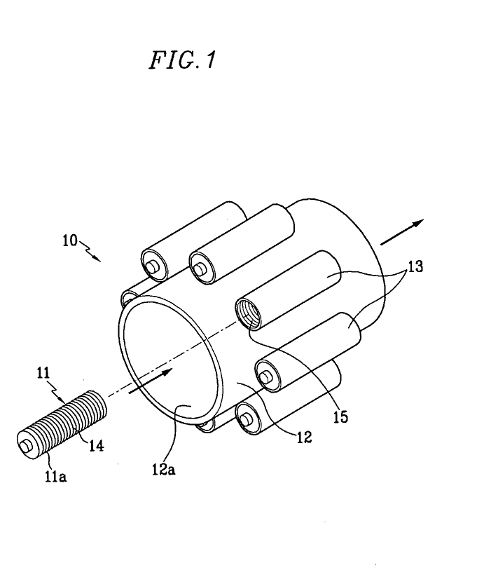

With reference to FIG. 1, a secondary battery module 10 includes a plurality of unit batteries 11, a body 12 having a channel 12a for a cooling medium to cool the unit batteries, and at least one battery receiving portion 13 (hereinafter “receiving portion”) mounted on an outer circumferential surface of the body 12 and parallel with the longitudinal axis of the body 12. The receiving portion 13 may be fixed to the body 12 by welding.

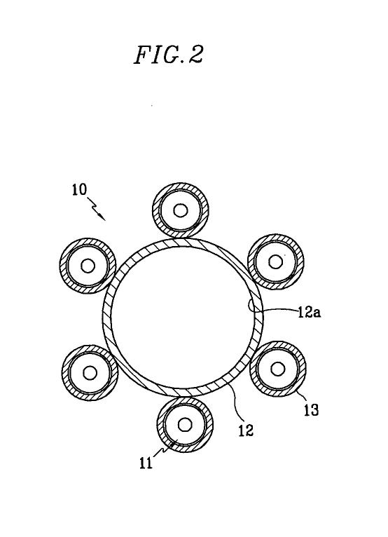

As shown in FIG. 2, the body 12 has a circular cross section, and the receiving portions 13 are arranged on the outer circumferential surface of the body 12 spaced from each other. That is, the receiving portions 13 are radially arranged on the body 12.

In the present embodiment, the unit battery 11 has a cylindrical shape, and the receiving portion 13 corresponds to the shape and size of the unit battery 11.

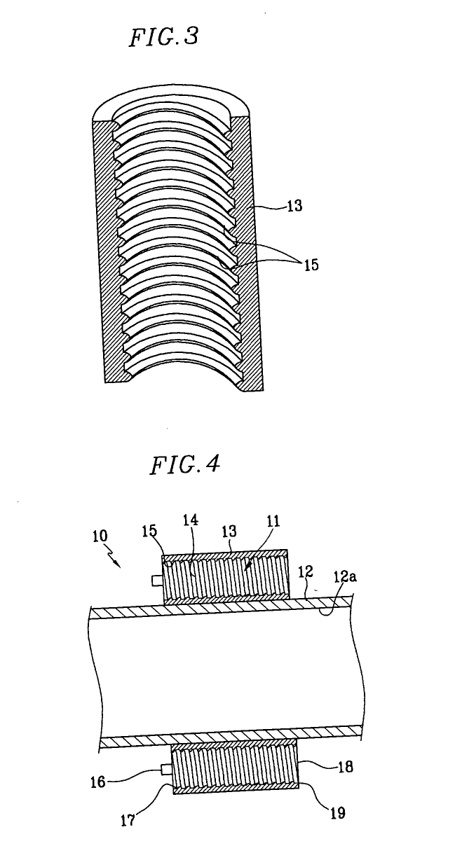

A male screw thread 14 (FIG. 1) is formed on the outer circumferential surface of a container 11a of the unit battery 11, and a female screw thread 15 (FIG. 3) is formed on the inner circumferential surface of the receiving portion 13.

Accordingly, the unit battery 11 may be combined with the receiving portion 13 by a screw thread fixation method. However, the present embodiment is only one example so it is not necessary that the unit battery be combined with the receiving portion only by the above screw thread method.

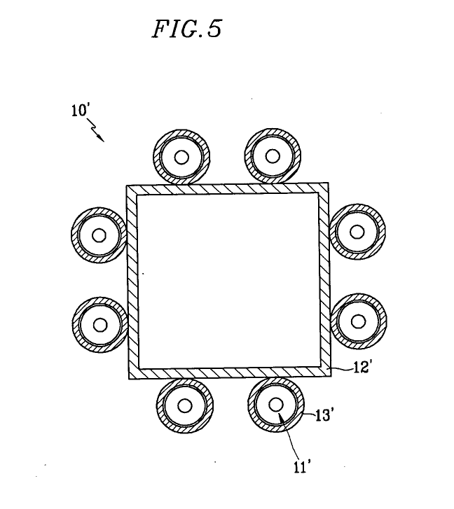

As shown in FIG. 3, the receiving portion 13 is shaped as a cylinder with an opening at either end. When the unit battery 11 is inserted by the screw thread fixation method, a positive terminal 16 of the unit battery 11 is exposed at a first end 17 and a negative terminal 18 of the unit battery 11 is exposed at a second end 19, as shown in FIG. 4.

The positive terminal of the unit battery 11 may be a cap plate of a cap assembly of the unit battery, and the negative terminal of the unit battery 11 may be a container of the unit battery. A plurality of unit batteries 11 mounted on the body 12 may be connected serially or in parallel.

A cooling medium introduced into the body 12 may be air. However, cooling media such as water or other fluids may also be used.

In addition, there is no limitation on the size of the body 12, which may be dependent of the number of the unit batteries mounted on the outer circumference.

The body 12 and the receiving portion 13 may be made from a highly heat conductive material such as aluminum or copper to increase emission rate of heat generated by the unit battery 11. In such case, an insulating member (not shown) may be interposed between the unit battery 11 and the receiving portion 13 to insulate the unit batteries.

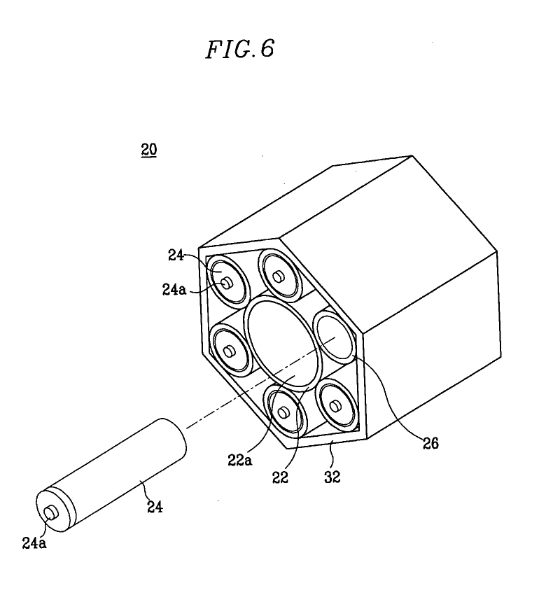

FIG. 5 shows a body 12′ having a rectangular pipe-like cross section. In this embodiment, the body 12′, the unit battery 11′, and the receiving portion 13′ of the secondary battery module 10′ have the same basic structure as those of the embodiment described above, the only difference being that the body 12′ has a rectangular cross section. Due to such a structure, the receiving portions 13′ are disposed on the side surfaces of the body 12′. The body may also be shaped with a pentagonal, hexagonal, or polygonal cross section.

The following will describe the function of the secondary battery module shown in FIGS. 1-5. The secondary battery module 10, 10′ has a plurality of unit batteries 11, 11′ mounted on the body 12, 12′. Air as a cooling medium is circulated through the channel 12a of the body 12 to cool the heat generated by the unit batteries 11.

Since the unit batteries 11,11′ are radially arranged on the body 12, 12′ with respect to the channel through which the cooling medium flows, each unit battery 11, 11′ may have a uniform contact distance from the cooling medium. Thus, the unit batteries 11,11′ may be uniformly cooled.

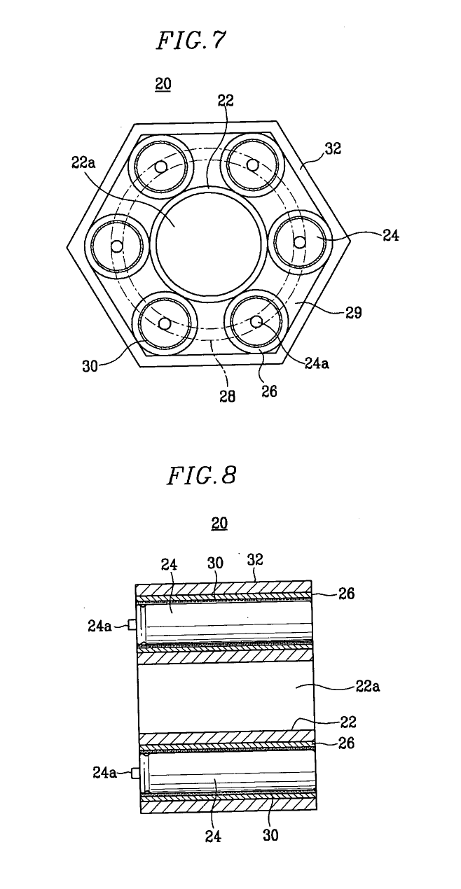

FIGS. 6-8 show a secondary battery module according to another embodiment of the present invention. The secondary battery module 20 has substantially the same basic structure as the secondary battery module described above. That is, the secondary battery module 20 has receiving portions 26 radially arranged on a body 22 having a channel 22a, and a unit battery 24 insertable and fixable to the receiving portion 26.

The unit battery 24 may be inserted into the receiving portion 26 by a forced insertion method such as a press fit. However, the unit battery may be fixed by a screw thread fixation method as described above.

In this secondary battery module 20, the unit batteries 24 may be electrically connected in parallel, and an adaptor 28 (shown in phantom in FIG. 7) contacts each terminal 24a of the unit batteries 24 to electrically connect them.

An insulating member 30 may be disposed between the unit battery 24 and the receiving portion 26 to substantially insulate them. The insulation member 30 may include a general synthetic polymer material such as phenol resin, polyurethane, polyester resin, polyamide, acryl, urea/melamine resin, silicon resin, etc. Alternatively, the insulation member may include insulating material of a varnish type such as insulating varnish, etc.

The secondary battery module 20 may further include an outer case 32 surrounding the body 22 and the receiving portions 26, wherein the outer case contacts the receiving portions 26 to support them. The outer case 32 may have a pipe-like hexagonal cross section. The outer case 32 functions as a housing for the secondary battery module 20, and supports a plurality of the receiving portions 26 to strengthen the fixing state and reinforce the overall strength of the secondary battery module 20.

Furthermore, when a cooling medium passes through the channel 22a of the body 22, the outer case 32 may also function to guide the cooling medium into the space 29 between the receiving portions 26.

The following will describe the function of the secondary battery module 20 shown in FIGS. 6-8. Each unit battery 24 is arranged on an outer circumferential surface of the body 22. The unit batteries 24 are inserted into the receiving portion 26 mounted on the body 22 to be radially mounted with respect to the body 22. Accordingly, they are spaced from each other at a predetermined distance.

Furthermore, as the receiving portion 26 reinforces its arrangement state and fixing state by the outer case 32 and thereby the overall strength of the secondary battery module 20 is reinforced, the inserted unit battery 24 can secure the fixing state for the receiving portion 26.

When a cooling medium is circulated through the channel 22a of the body 22, heat generated by the unit batteries 24 may be uniformly discharged because each unit battery 24 uniformly contacts the body 22, i.e., each unit battery 24 has the same contact area with the body 22. Thus, heat exchange with the cooling air passing through the body 22 can be conducted under the same conditions for each unit battery 24. In addition, since the body 22 is positioned in the middle of the unit batteries 24, the cooling air passing through the body 22 uniformly provides a cooling effect to all unit batteries 24 without deviation toward any specific unit battery 24.

During the cooling process, some of the cooling air provided to the channel 22a of the body 22 from outside the secondary battery module 20 may be channeled into the space 29 between the outer case 32 and the body 22. Such cooling air cools the unit battery 24 separately from cooling air flowing through the channel 22a of the body 22, enhancing cooling efficiency of the unit battery 24.

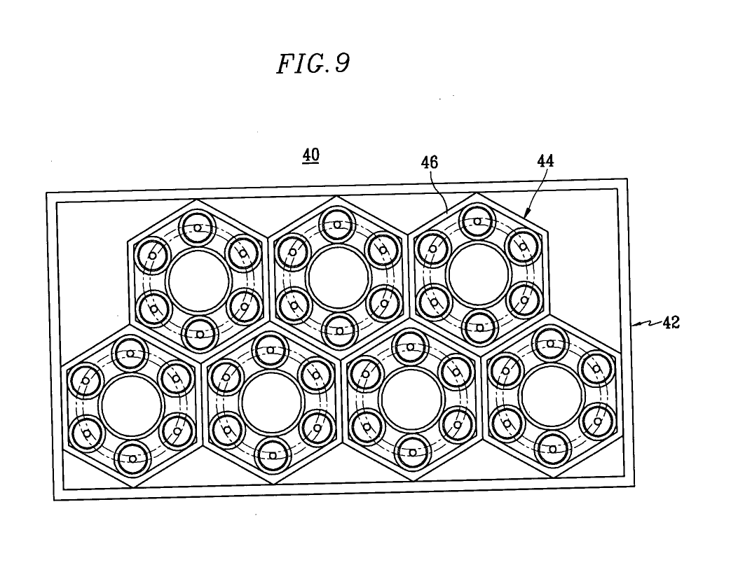

With reference to FIG. 9, a secondary battery module 40 has a plurality of the secondary battery modules as sub modules packaged inside a container 42 of a predetermined shape.

In this embodiment, at least two rows of the sub modules 44 are arranged in the container 42, and their outer hexagonal cases 46 are in close contact to form a honeycomb structure.

In addition, in an alternate embodiment, the container 42 functions as a housing having a square cross section to package a plurality of the sub modules 44.

In such secondary battery modules 40, since the sub modules 44 are in close contact with each other, and are also in close contact with the inner wall of the container 42, there is no space between the sub modules 44 within the inner space of the container 42. Accordingly, sufficient cooling of the unit battery and optimal use of the space within the limited inner space of the container 42 may be achieved.

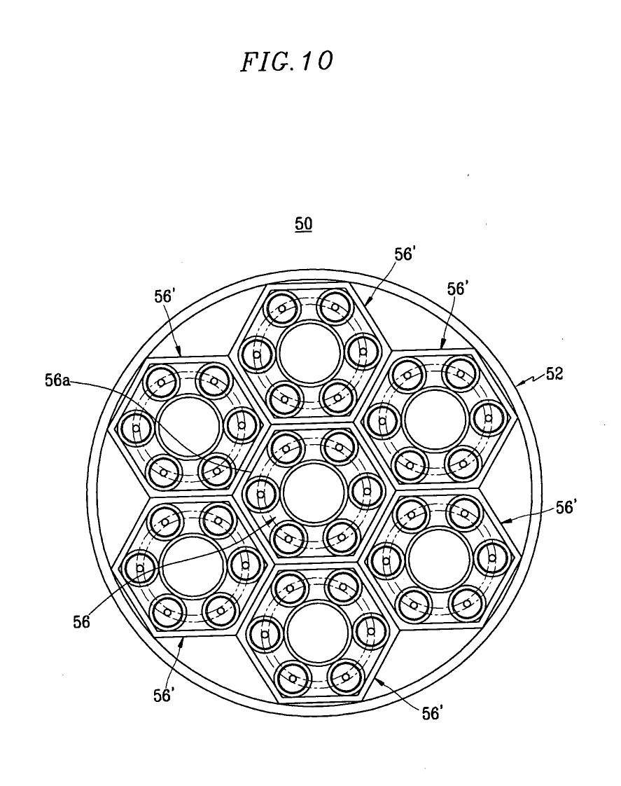

The secondary battery module 50 of another embodiment shown in FIG. 10 has the same basic structure as the embodiment of FIG. 9, but a container 52 has a circular cross section.

That is, in the secondary battery module 50, one sub module 56 is arranged in the middle of the inside of the container 52, and several sub modules 56′ are in close contact with each wall of an outer case 56a of the sub module 56.

Several sub modules 56′ are in close contact with the inner wall of the container 52 so that there is no gap or space between these sub modules 56 and 56′ within the inner space of the container 52.

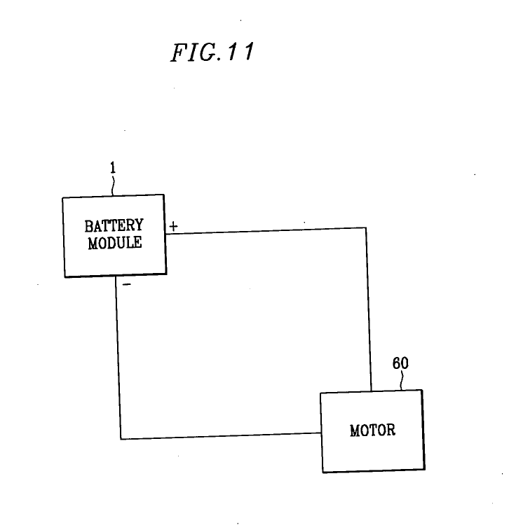

The secondary battery module according to the present invention may be used as the power source for motor driving devices, such as the hybrid electric vehicles, electric vehicles, wireless vacuum cleaners, motorbikes, or motor scooters. FIG. 11 is a schematic block diagram of a battery module 1 which includes the rechargeable batteries driving a motor 60.

According to the present invention, the arrangement of the channel for the cooling medium and the unit battery of the secondary battery module is improved to achieve an effective cooling efficiency of a unit battery.

In addition, since the cooling medium is uniformly circulated between the unit batteries, the partial heat imbalance over the entire secondary battery module may be prevented.

Furthermore, since a plurality of unit batteries may be compactly arranged within the limited space, the characteristics for the entire secondary battery module may be maximized.

Although exemplary embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A secondary battery module comprising:
a body having a channel for channeling a cooling medium; and
a plurality of receiving portions mounted on the body;
wherein unit batteries are insertable into the plurality of the receiving portions.

2. The secondary battery module of claim 1, wherein the plurality of receiving portions are radially arranged on and fixed to the body.

3. The secondary battery module of claim 2, wherein the plurality of the receiving portions are fixed to an external surface of the body by welding.

4. The secondary battery module of claim 1, wherein the body is cylindrical.

5. The secondary battery module of claim 1, wherein the body has a polygonal cross section.

6. The secondary battery module of claim 1, wherein a unit battery is combinable with a receiving portion by a screw thread fixation method.

7. The secondary battery module of claim 1, wherein a unit battery is combinable with a receiving portion by a forced insertion method.

8. The secondary battery module of claim 1, wherein each receiving portion has a shape corresponding to a shape of a unit battery.

9. The secondary battery module of claim 1, wherein the body and the plurality of receiving portions are made of aluminum or copper.

10. The secondary battery module of claim 1, wherein an insulating member is interposed between each receiving portion and a unit battery inserted into the receiving portion.

11. The secondary battery module of claim 1, further including an outer case surrounding the body and the plurality of receiving portions, the outer case being supported by the plurality of receiving portions.

12. The secondary battery module of claim 11, wherein the outer case has a hexagonal cross section.

13. The secondary battery module of claim 11, wherein a plurality of secondary battery modules are mounted in a container.

14. The secondary battery module of claim 13, wherein the secondary battery modules are arranged in a honeycomb structure.

15. The secondary battery module of claim 13, wherein the container has a square or circular cross section.

16. The secondary battery module of claim 1, wherein a unit battery has a cylindrical shape.

17. The secondary battery module of claim 1, wherein the secondary battery module drives a motor.

18. The secondary battery module of claim 1, wherein each unit battery is insertable into a receiving portion such that each positive electrode is coupled to a common adapter for connecting each unit battery in parallel.
